(19) United States
(12) Patent Application Publication
(10) Pub. No.: US 2005/0044159 A1
(43) Pub. Date: Feb. 24, 2005

(54) Messaging system

(76) Inventors: Aki Niemi, Helsinki (FI); Tommi Komulainen, Espoo (FI); Sapan J. Bhatia, New Delhi (IN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/493,161

(22) PCT Filed: Oct. 16, 2002
(86) PCT No.: PCT/IB02/04272

(30) Foreign Application Priority Data
Oct. 19, 2001 (GB) 0125201.4

(51) Int. Cl. G06F 15/16

(52) U.S. Cl. 709/207

(57) ABSTRACT

A messaging system for provision of instant messaging for a user entity (1) is disclosed. The user entity of a type that is adapted for communication via a first communication environment (10) based on a first protocol. The messaging system comprises a controller entity (6) for managing instant messaging between user entities (1-4) in the messaging system. The controller entity is provided in a second communication environment (12) and operates in accordance with a second protocol. The controller entity comprises means for maintaining information regarding the status of said user entity.

### FIELD OF THE INVENTION

The present invention relates to a messaging system, and in particular to provision of instant messaging services for users of a communication system.

### BACKGROUND OF THE INVENTION

A communication system is a facility that enables communication between two or more entities such as user terminal equipment and/or other nodes associated with the system. The communication may comprise, for example, communication of voice, electronic mail (email), text messages, data, multimedia and so on. The communication may be provided via fixed line and/or wireless communication interfaces. An example of communication systems providing wireless communication is a public land mobile network (PLMN). An example of the fixed line systems is a public switched telephone network (PSTN).

A communication system typically operates in accordance with a given standard or specification which sets out what the various elements of the system are permitted to do and how that should be achieved. For example, the standard or specification may define if the user, or more precisely, user equipment or terminal is provided with a circuit switched service or a packet switched service or both. Communication protocols and/or parameters which shall be used for the connection are also typically defined. For example, the manner how communication shall be implemented between the user equipment and the elements of the communication network is typically based on a predefined communication protocol. In other words, a specific set of “rules” on which the communication can be based on needs to be defined to enable communication by means of the communication system.

The communication systems may be provided with various different functions. These functions can be divided in different categories. A category comprises functions that relate to the actual carrying of the communication in the system. Another category can be seen as being formed by control or management functions such as the control of various services. The various functions of the communication systems may have been developed quite independently from each other and may use different protocols in different communication systems.

For example, in communication environments such as those based the Internet Protocol (IP) or the Session Initiation Protocol (SIP) or the current third generation (3G) communication network architectures it is assumed that various servers are used for handling of the provision of different communication services for users. In such communication systems the communication connections may not be based on a “circuit” between the communicating nodes, but the messages may rather be transported as packets that are provide with an address. Hence the name packet switched systems. The server entities and the user equipment may communicate with each other based on appropriate protocol providing such a connectionless operation.

The internet protocol (IP) is a layer 3 protocol that underlies the application layer in a layered communication system function model. The Session Initiation Protocol (SIP) in turn is an application-layer control protocol for creating, modifying and terminating sessions with one or more participants. A user connected to a SIP based communication system may communicate with various entities of the communication system based on standardised SIP messages.

The word Internet is typically understood as referring to the Hypertext Transfer protocol (HTTP) based World Wide Web (WWW). The Internet has already proven to be a popular and wide spread data communication system and is commonly used for provision of different services for the users thereof. In the Internet services are typically provided by the so called Internet Service Providers (ISPs). In addition to provision of the communication services itself (i.e. the possibility to communicate via the system), content services such as different web sites are also provided. The content can have any form, such as information, multimedia and so on.

Users of the Internet have been able to subscribe to the so called group messaging. The term group messaging refers to a feature in a messaging infrastructure of a communication system that enables a user to join discrete messaging groups. A user may join a messaging group of his/hers personal interest and communicate exclusively with the other members in that group on a messaging channel. Any user who has successfully joined a messaging group may post messages to other members of the group by referring to the group-enumerator. The members of the group also receive messages that are posted by the other members of the group. The messaging groups may be private (only selected members may join) or public (anybody may join). A user may belong to a number of messaging groups.

At present the probably best known example of the group messaging systems is the Internet Relay Chat (IRC). The IRC is a globally accepted standard for group messaging over the IP based Internet. The IRC is believed to have millions of users world-wide. A user connected to the Internet may communicate in real-time with a group of other users connected to the Internet via the IRC.

A user who wishes to join a messaging group needs to register e.g. his name on an IRC server and join an IRC messaging channel provided by the IRC server. Any other user who joins the same IRC messaging channel on this IRC server may then exchange messages with him. For example, if Alice, Bob and Jack wish to chat in a group by means of their Internet enabled terminals, they need first to select an IRC server (e.g. with address irc.abc.net), then select a channel (e.g. #ourchat) and join the channel using an appropriate IRC client software in their computer terminals. Once they all have done this any message posted on the channel by one of them is relayed to the other two members of the group. Other examples of the group messaging services include services such as the ICQ and Yahoo™ Messenger.

A feature of the group messaging systems is that they provide an instant messaging session between the members of the group. That is, the messaging occurs in real-time. Consequently the instant messaging requires that users who belong to the group and wish to attend the messaging session do it in real-time. If a member is not available or does not wish to answer, the other users do not necessarily get any indication of this, and may wait for a response for a substantial length of time. At the present this problem is typically solved such that a centralised server (such as the IRC) manages the registrations and keeps the individual members of the group informed about the availability of those members with whom said individual member may chat with. A problem usually exists with this in that the instant messaging is then only available for those users who communicate based on a protocol that mandates communication with the centralised messaging server. For example, if the messaging service is provided by an IRC server, the messages need to be transported based on TCP/IP (transmission control protocol/IP).

EP publication 1122926 A2 describes a communications system including a plurality of communities that may be served by different service providers. Text-based real-time messaging sessions may be established between users in said communities. A user in a first community may send a request indicating a desired text-based messaging session with a second user in a second community. The second user is notified of the request. A determination is made if the second user has accepted the request to establish a text-based messaging session. If so, the text-based messaging session is established between users in the first and second communities. EP 1122926 A2 describes also an architecture for provision of chat conferencing for users associated with service providers that do not have chat applications, the user being enabled to establish a chat connection via their service providers by using a web browser. However, although different groups may be served, EP 1122926 A2 does not propose any solution for enabling instant messaging for users of a communication system that is different to a communication system that is based on the TCP/IP.

The inventors have found that users of other communication systems than the Internet, such as those served by telephone network operators or operators of higher or lower protocol layer networks might wish to use group messaging services. The inventors have also found that the existing group messaging services are arranged to provide instant group messaging services only for those users who are communicating via a specific communication system (that is, TCP/IP based systems). In practice that means that only those users who may communicate via the TCP may join a chat group managed by a IRC server.

If another protocol, for example the with the Session Initiation Protocol (SIP), is extended to accommodate groups for instant messaging, these messaging groups then require implementation of presence and group messaging servers in that protocol environment. That is, if instant group messaging is to be provided in a communication system that operates in accordance with the Session Initiation Protocol (SIP) the groups would have to be maintained on a SIP server. Introduction of additional servers in the SIP communication environment, however, might add to the complexity and cost of the communication system. Interaction of the SIP messaging groups with other group messaging systems and presence functions might also be difficult to implement. Also, the operators of the SIP servers would have to implement features such as security functions and other administrative and management properties and so on.

### SUMMARY OF THE INVENTION

Embodiments of the present invention aim to address one or several of the above problems.

According to one aspect of the present invention, there is provided a messaging system for provision of instant messaging for a user entity adapted for communication via a first communication environment based on a first protocol, the messaging system comprising a controller entity for managing instant messaging between user entities in the messaging system, wherein said controller entity is provided in a second communication environment, operates in accordance with a second protocol and comprises means for maintaining information regarding the status of said user entity.

In a more specific form a server is arranged to operate in the first communication environment for relaying communications between the user entity and the messaging controller entity. The server may be arranged to adapt messages from the messaging controller entity so that the messages can be processed by the user entity and to adapt messages from the user entity so that the messages can be processed by the messaging controller entity. The server may be arranged to act as a client for the messaging controller entity. A user entity may join a messaging group maintained by the controller entity by signalling a message in accordance with the first protocol to the server. Said server generates and signals a request to the controller entity based on said message.

An executable set of instructions may be provided for controlling of communications between the controller entity and the user entity.

The controller entity nay be arranged to provide the user entity with information regarding the presence status of other user entities that have joined a messaging group maintained by the controller entity.

According to another aspect of the present invention there is provided a messaging server for provision of instant messaging for first user entities adapted for communication via a first communication environment in accordance with a first protocol and also for second user entities adapted for communication via a second communication environment in accordance with a second protocol, said messaging server being provided in said second environment and comprising means for maintaining information regarding the status of the first user entities.

According to another aspect of the present invention there is provided a method in a communication system for provision of instant messaging between user entities, at least one of the user entities communicating via a first communication environment based on a first protocol, the method comprising: maintaining in a controller entity information regarding the status of said at least one user entity, said controller entity being provided in a second communication environment operating in accordance with a second protocol; signalling from the controller entity a message to the at least one user entity; and receiving the message in the at least one user entity, said message being signalled via the first communication environment.

In a more specific form a user entity may request for a membership in a messaging group managed by the controller entity by sending a request to a server provided in the first communication environment. Status information regarding said at least one user may be signalled from the controller entity. A notification may then be given to a user of a user equipment.

The embodiments of the invention may enabled a feasible way to move presence and group messaging functions out from one network domain. For example, it should be easier to implement group messaging for groups who subscribe to a communication network that itself does not provide group messaging facilities. That is, the group messaging services may be provided by means of a messaging server that is arranged externally from said communication network. Group messaging services may be provided for users of other communication systems by means of e.g. a group messaging entity implemented in the Internet. The embodiments may also enable group messaging for users who are communication via different types of user terminals and communication systems.

The implementation of the proposed system does not require any substantial investment since it is possible to utilise already existing group messaging facilities, e.g. IRC servers implemented in the Internet. The operators of the other networks may utilise the administrative functions, security functions, enhanced features and so on that are already implemented in the existing group messaging entities.

### BRIEF DESCRIPTION OF DRAWINGS

For better understanding of the present invention, reference will now be made by way of example to the accompanying drawings in which:

FIG. 1 shows one embodiment of the present invention;

FIG. 2 shows a plurality of server entities that may co-operate to provide users with group messaging services;

FIG. 3 is a signalling flow chart in accordance with an embodiment;

FIG. 4 is a flowchart illustrating the operation of one embodiment of the present invention; and

FIG. 5 shows a further embodiment.

### DESCRIPTION OF PREFERRED EMBODIMENTS OF THE INVENTION

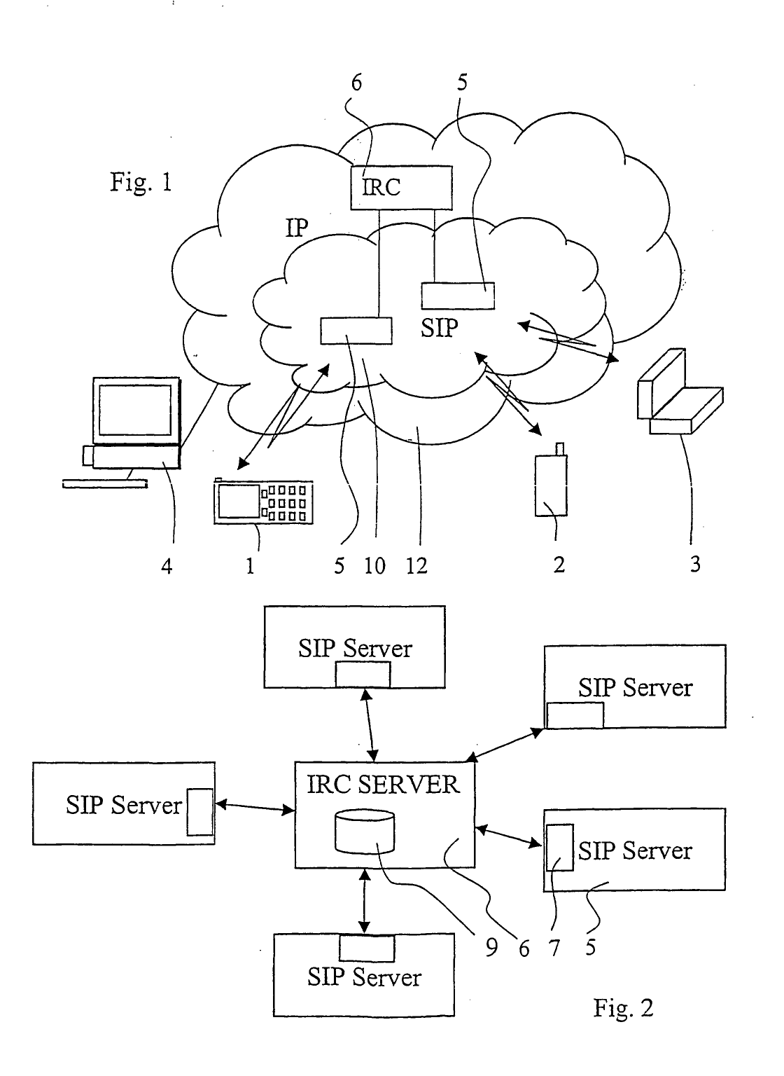

Reference is made to FIG. 1 which shows a messaging group consisting of three users 1 to 3. The users are connected via respective wireless interfaces to a first communication system 10. The first communication system 10 provides communication in a session initiation protocol (SIP) environment. That is, each of the users 1 to 3 subscribes to a communication system that is based on the SIP protocol. A SIP user equipment can be seen as equipment that can interpret and generate SIP messages, and it includes functions required for handling the SIP messaging referred to as a SIP user agent (UA).

The elements required for the wireless connection between the network apparatus of the first communication system 10 and the user equipment 1 to 3 and the user equipment as such do not form an essential element of he present invention, and therefore these are not shown or described in any greater detail. It is sufficient to note that mobile stations may communicate with base stations of a cellular communication system over a wireless interface. The mobile stations may be provided with user interface means such as a display and input or control buttons, although this is not always necessary. A mobile station may comprise also processor and data storage means for enabling use thereof for messaging operations.

FIG. 1 shows also a second communication system 12. The second communication system operates in accordance with a second protocol. More particularly, the second communication system operates in the Internet Protocol (IP) environment.

A group messaging controller entity 6 is shown to be provided in the IP environment 12. In a preferred embodiment the group messaging controller entity 6 comprises an Internet Relay Chat (IRC) server. IRC servers have been conventionally used for provision of group messaging channels for user of Internet enabled terminals such as the personal computer (PC) terminal 4 of FIG. 1.

The inventors have found that it is possible to utilise a server that is originally intended for use in a different communication environments, such the IRC server 6 implemented in the IP environment 12, for provision of presence and group messaging functions in a communication system that is based on another protocol, for example the SIP.

The group messaging and presence functions may be enabled for user 1 to 3 in the SIP environment 10 by using the IRC server 6 of the IP environment 12 at the back-end. Instant group messaging may be provided for the SIP users 1 to 3 by joining the SIP users on a specific user group. All messages within the group may then be relayed to the SIP user group by posting them on a corresponding IRC channel. That is, the SIP users 1 to 3 may join a server-specific (internally defined) channel provided by the IRC server 6 whenever they signal a request to register onto the channel. The SIP users can also be removed from the channel provided by the IRC server 6 when they de-register.

The IRC server 6 functions as a sort of a presence storage that keeps the state of the user registrations in the database 9 thereof. In accordance with the principles of the present invention the status is information is also kept for users 1 to 3 who belong to a different communication system. That is, the IRC server 6 of FIG. 1 provides presence information associated with the registered users regardless the communication system they subscribe to.

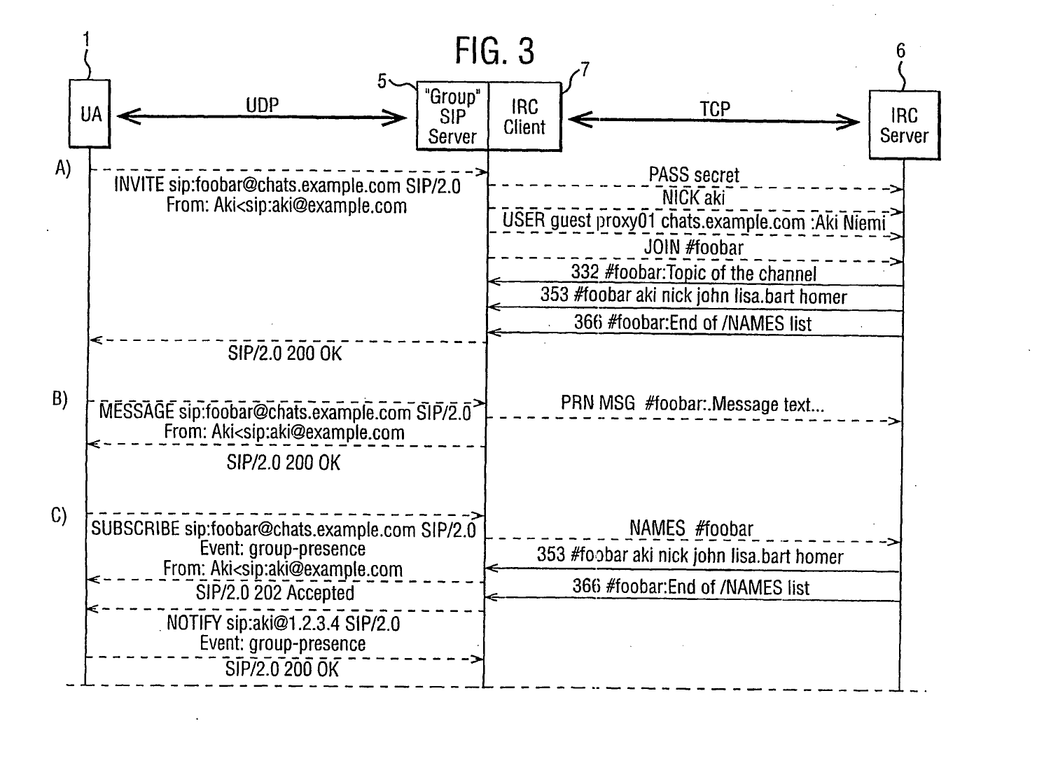

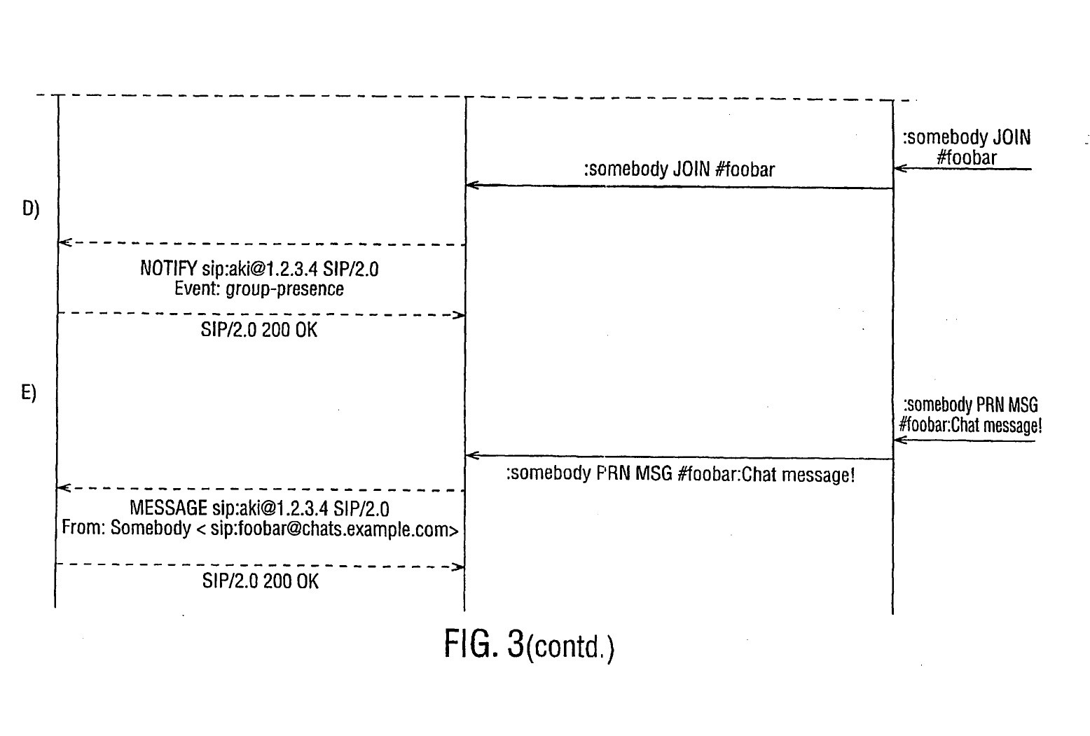

The communication between a SIP server and the IRC server may be handled by an appropriate client entity. FIGS. 2 and 3 show an embodiment wherein such as a client entity 7 is provided in association with the SIP server entities 5.

The client entity 7 may comprise an executable set of instructions such as a script or executable program code adapted for provision of instant messaging services for the SIP users. When a SIP server 5 receives the requests from a user equipment the SIP server may execute the script thereby enabling communication between the SIP user 1 and the IRC server 6. The script may perform any adaptation of the signalling between the IRC 6 and the user equipment 1 that is required so that the SIP and IRC entities may communicate with each other.

For example, a particular script that interfaces the SIP communication environment to the IP communication environment thereby enabling communication between the SIP users 1 to 3 and the IRC server 6 may be invoked by an event wherein a user subscribes to a channel on the IRC server 6. The script may be, for example, based on any of the following: a CGI (Common Gateway Interface, a WWW based technology); a PHP (Hypertext Preprocessor, a WWW scripting language); a PERL (Practical Extraction and Reporting Language, a Script programming language).

Adaptation of the messages at the SIP server 5 may be required e.g. since the messages are sent on the IRC channel in accordance with the IRC protocol. The IRC protocol messages are not necessarily understood by a SIP enabled equipment and vice versa. Thus, since the IRC server is not necessarily arranged to interpret or generate SIP messages, the messages from the IRC server 6 may need to be converted to a format that the user equipment 1 may understand.

In the example described in more detail with reference to FIG. 3, the client entity 7 is arranged to compile SIP messages from the protocol data packets received from the IRC server 6. In the other direction the client entity may generate protocol data packets from the SIP messages received from the user equipment 1.

The IRC back-end server 6 can be implemented invisibly within the system, that is the SIP users 1 to 3 do not necessarily know that they are in communication with a server of another system. Instead, the SIP users see the SIP server 5 as an entity that provides the instant group messaging services. For example, a SIP message to a SIP destination <sip:hobby-football@service.provider.com> is relayed transparently to an IRC channel called #hobby-football.

The IRC server 6 may see the SIP server 5 as a normal client i.e. as any member who wishes to join an instant messaging channel maintained by the IRC server. The IRC server will relay any messages coming into the channel to the client as it were any other member of the channel. A SIP server 5 may have several IRC clients 7 running at the same time, one for each SIP user. The IRC server 6 would see these user as IRC clients residing in one server or IP address.

The IRC channels can be joined by the SIP users and also by the direct IRC users. Thus the channels can provide a gateway between the SIP and IRC users. It shall be appreciated that in the SIP environment the “channel” is sometimes referred to by the term “group”, both of these terms referring to a similar functionality.

Instant messaging requires information regarding the presence status of a member of the group. In the FIG. 2 embodiment the IRC server 6 is arranged to maintain in a memory means 9 thereof information regarding the presence status of the users subscribing to the group messaging services. The memory means may comprise any appropriate means for storing status information, such as a volatile or a non-volatile memory chip, disk or similar. A set of executable instructions such as an appropriate script may be used for controlling the presence functionality of the IRC server 6 in a per se known manner.

During the operation the IRC server 6 may be provided with a request to provide a listing of all active channel participants. The listings may be conveyed on the channel the users have joined. When a user leaves the channel, all other members of that channel may be sent a notification regarding the change of the status of the user.

This information may be translated into an appropriate message format at the SIP server 5 and then forwarded to user equipment belonging to said channel. Thus information about the presence status of the other channel participants is provided for each member of the group. Other state changes can also be reporting accordingly. That is, the presence mechanism of the IRC server can be used to communicate any information that associates with the status of the group.

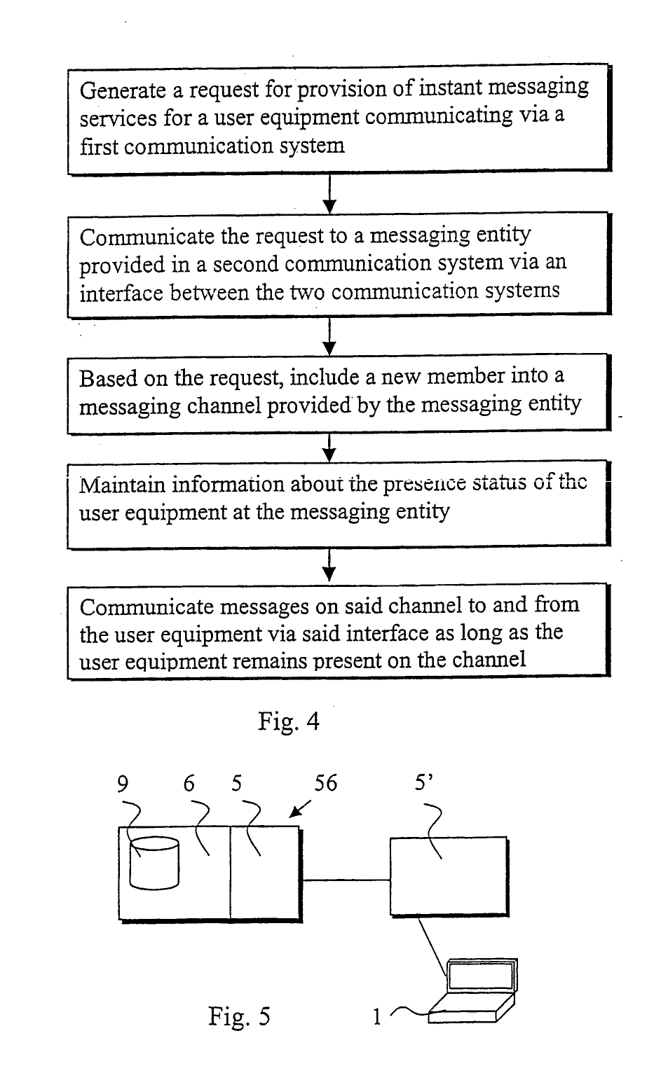

A more detailed example of the instant messaging in accordance with the present invention is now explained with reference to the signalling chart of FIG. 3 and also flowchart of FIG. 4. As shown in FIG. 3, a SIP user equipment (user agent) 1 may use standard SIP functions to join IRC channels provided by an IRC server 6 and for communication on said channels. The SIP user equipment 1 is arranged to send SIP SUBSCRIBE/INVITE requests to a SIP server 5 and to receive standard SIP NOTIFY or MESSAGE messages from the SIP server. These SIP messages can be employed in the provision of various features of the instant group messaging services provided by the IRC server 6 for the SIP user equipment 1.

The IRC server 6 is shown to communicate by means of TCP (Transmission Control Protocol). Communication between the SIP user equipment 1 and the SIP server 5 is shown to be based on UDP (User Datagram protocol). A difference between these two protocols is that in the TCP all packets carrying the messages are acknowledged by the recipient entity and the messages are carried in a specific order whereas in the UDP the packets are not acknowledged and an orderly delivery is not guaranteed. Instead, the SIP itself provides a mechanism for acknowledging the receipt of messages and for guaranteeing the orderly delivery of the messages. Therefore an adaptation between the TCP and UDP and also between SIP and IRC protocols is required in the SIP entity.

In step A a user ‘Aki’ of the user equipment 1 wishes to join a group by sending an SIP ‘INVITE’ to the SIP server 5. An IRC client 7 provided in the SIP server 5 then communicates with the IRC server 6 in order to join the user ‘Aki’ on the requested channel. A ‘join’ request is send to the IRC 6. The ‘join’ request is based on information contained in the INVITE request from the user equipment 1, said request identifying the user ‘Aki’ and the requested channel ‘Example’. Any responses from the IRC server 6 are relayed to the SIP group messaging server 5. Based on the response the SIP server 5 may send, for example, a success/failure SIP message to Aki's user equipment and so on.

After the communication between the SIP server 5 and the IRC server 6 is completed successfully, an ‘OK’ message is returned to Aki's user equipment. As indicated by step B, the user equipment 1 may now send messages to the group via the SIP server 5 and by means of the IRC client 7. Responses (i.e. messages from other users) may be transported to the registered user e.g. by means of SIP ‘MESSAGE’ or ‘NOTIFY’ messages.

At the IRC server an IRC presence script can be used to log the user on to the IRC server with the user nickname ‘Aki’ set to the SIP URL of the user. After the script has performed a ‘/join #<group-name>’ operation any messages posted on the group are relayed to ‘Aki’ through callback features to the client script 7 at the SIP server 5. The messages are then delivered through a SIP ‘MESSAGE’ (for messages) and ‘NOTIFY’ (for presence notifications) to the user equipment 1.

The user of the user equipment 1 may also send an enquiry regarding the presence status of the other members of the group. In step C this is done by means of a SIP ‘SUBSCRIBE’ request. More particularly, the user may use his SIP enabled terminal to subscribe to an “IRC presence script” on the SIP server 5, pointing to a particular group name. The ‘SUBCRIBE’ specifies an event to which the message is for. The SIP server 5 may bind the requested event to the appropriate script which is then executed to provide the requested service, which is this case was the “IRC presence script”.

Responses (i.e. names of other users who are present at the moment) may then be transported to the user e.g. by means of SIP ‘NOTIFY’ messages. The SIP NOTIFY messages may not carry documents which are specified by other protocols. The SIP server, and more particularly, the script running the service in the SIP server translates the IRC messages e.g. into a corresponding presence document. Therefore, if the SIP server 5 is adapted to operate in accordance with the presence specifications, it will then send only presence updates which the SIP enabled user equipment understands. So the user equipment would see the received document as an ordinary presence application. A more detailed description of the SIP presence service provided by SIP server entities can be found from 3^{rd} Generation Partnership Project (3GPP) Technical specification 3GPP TS 22.141 ‘Presence Service’ (version 1.0.0. 2001-06).

The users of the SIP communication system may thus form a SIP messaging group by the IRC server 6. In addition to transportation of the actual messages, any other events pertaining to this IRC channel, such as inclusion of a new member, exclusion of a registered member may also be relayed to the members through standard SIP messages, for example through the SIP ‘NOTIFY’ messages. This is illustrated in step D wherein a new member joins the group.

Step E illustrates the relaying of a message from another member of the group to user 1.

The user equipment may be arranged to give noticeable indications to the user thereof based on the messages received from the SIP server. For example, the user equipment may display to the user a green icon on a person who is in an active state, and a red icon when that person is inactive.

FIG. 3 shows use of SIP INVITE messages for joining a group and SIP SUBSCRIBE for obtaining presence information. It is also possible to join the chat sessions (streams of messages from/to the channel or messaging group) by sending a SIP SUBSCRIBE message. Requests for information regarding the presence status of group participants (joins, leaves, kicks or other state changes of a channel) may be requested by means of a SIP INVITE message. Users may also be enabled to use either SIP INVITE or SIP SUBSCRIBE for both of these operations.

As shown in FIG. 2, one IRC based group messaging/presence server entity 6 may be shared by a plurality of SIP servers 5.

FIG. 5 shows a further embodiment wherein the functions of a SIP server entity 5 and an IRC server entity 6 are implemented by means of as integrated unit 56. This embodiment does not necessarily require use of clients or other similar adaptation means between the SIP server and IRC server entities. Instead, the functions thereof can be integrated such that the messages input to unit 56 and output from unit 56 are already of format that can be carried in the SIP communication environment and interpreted by the SIP user equipment 1. FIG. 5 shows also a SIP proxy server 5″ via which the SIP messages between the unit 56 and the user equipment 1 may be carried in a per se known manner.

It shall be appreciated that users of the instant messaging service do not necessarily need to be human users. For example, entities of a communication system or entities connected to a communication system may exchange automatically e.g. control messages via an instant messaging system that is arranged to operate in accordance with the above discussed principles.

In the above discussed embodiments the presence and group messaging are moved out of a pure SIP domain. It shall be appreciated that the SIP users may also use other instant messaging IM clients that those described above. For example, ICQ, AOL an so on may be used for communication with user groups. What is required is that such a client has a gateway to the IRC in order to send/receive messages from the IRC channels. In addition, other messaging system than the described IRC can be used for the provision of the chat channels. For example, any WWW based messaging system such as those available under trade names ICQ™, AIM™ or Yahoo Messenger™ can be used for the provision of the messaging controller entity for instant messaging.

A gateway entity may be provided for the interface between communication systems operating in accordance with different protocols. For example, a gateway may be provided with a SIP server and the IRC server. However, this is not necessary e.g. when the SIP server acts as an IRC client thus providing means for interfacing the two systems.

If somebody using e.g. a WWW based messaging system wishes to communicate with a SIP user, or inter-operate with other communication environments, it is useful to have the messaging function implemented externally from the communication network the SIP user or user of other communication environment subscribes to. This enables also users of different types of user terminal equipment to participate a messaging group. For example, the PC terminal 4 in FIG. 1 may join the group created for users 1 to 3 of the SIP network.

The implementation of the above discussed group messaging method is substantially lightweight and convenient since e.g. the IRC servers are already scattered all over the Internet. Therefore a communication system that operates in a different protocol environment, such as in accordance with the SIP, may be extended to provide the users thereof with group messaging services without a need to provide the communication system with additional servers. The existing IRC servers have also proven to be robust and flexible. The operators of the SIP networks may utilise the administrative functionality, security, enhanced features and so on that are already implemented in an IRC. That is, features provided by the IRC based systems can be re-used in the SIP based system e.g. for channel set-up, administration, message delivery, and so on.

It shall be appreciated that whilst embodiments of the present invention have been described in relation to SIP enabled mobile stations and SIP and IP protocol environments, embodiments of the present invention are applicable to any other suitable type of user equipment and protocols.

It shall also be appreciated that instant messaging can be provided between two user entities only.

It is also noted herein that while the above describes exemplifying embodiments of the invention, there are several variations and modifications which may be made to the disclosed solution without departing from the scope of the present invention as defined in the appended claims.

1-22. (Cancelled).

23. A messaging system for provision of instant messaging for a user entity adapted for communication via a first communication environment based on a first protocol, the messaging system comprising a controller entity for managing instant messaging between user entities in the messaging system, wherein said controller entity is provided in a second communication environment, operates in accordance with a second protocol and comprises means for maintaining information regarding the status of said user entity, and a server arranged to operate in the first communication environment for relaying communications between the user entity and the messaging controller entity.

24. A system as claimed in claim 23, wherein the server is arranged to adapt messages from the messaging controller entity so that the messages can be processed by the user entity and to adapt messages from the user entity so that the messages can be processed by the messaging controller entity.

25. A system as claimed in claim 23, wherein the server is arranged to act as a client for the messaging controller entity.

26. A system as claimed in claim 23, wherein an executable set of instructions is provided for controlling of communications between the controller entity and the user entity.

27. A system as claimed in claim 23, wherein the controller entity is arranged to provide the user entity with information regarding the presence status of other user entities that have joined a messaging group maintained by the controller entity.

28. A system as claimed in claim 23, wherein a user entity is enabled to join a messaging group maintained by the controller entity by signalling a message in accordance with the first protocol to the server, and wherein said server generates and signals a request to the controller entity based on said message.

29. A system as claimed in claim 23, wherein in said first communication environment communication messages transmitted to and from the user equipment are acknowledged by the recipient thereof and in said second communication environment the communication is carried by means of data stream, wherein each data packet in the data stream is acknowledged by the recipient thereof.

30. A system as claimed in claim 29, wherein in said first communication environment the communication is carried by mean of User Datagram Protocol (UDP) data packets and in said second communication environment the communication is carried by means of Transmission Control Protocol (TCP) data packets.

31. A system as claimed in claim 23, wherein the controller entity is arranged to send notifications to users that have joined a messaging group maintained by the group messaging entity.

32. A system as claimed in claim 31, wherein a notification comprises information regarding at least one of the following events: inclusion of a new member in a messaging group; exclusion of a member from a messaging group; a new message; status of a member of a group.

33. A system as claimed in claim 23, wherein the controller entity and the server are provided by means of a single network element.

34. A system as claimed in claim 23, wherein the first protocol comprises the Session Initiation Protocol (SIP).

35. A system as claimed in claim 23, wherein the second protocol comprises the Internet Relay Chat (IRC) protocol.

36. A system as claimed in claim 23, wherein the controller entity provides a gateway between user entities communication via the first communication environment and user entities communicating via another communication environment.

37. A system as claimed in claim 23, wherein the controller entity comprises a Internet Relay Chat (IRC) server.

38. A system as claimed in claim 23, wherein at least one of the user entities comprises a user equipment arranged for communication via wireless interface.

39. A system as claimed in claim 23, wherein the user entity comprises an element implemented within the first communication environment.

40. A messaging server for provision of instant messaging for first user entities adapted for communication via a first communication environment in accordance with a first protocol and also for second user entities adapted for communication via a second communication environment in accordance with a second protocol, said messaging server being provided in said second environment and comprising means for maintaining information regarding the status of the first user entities.

41. A method in a communication system for provision of instant messaging between user entities, at least one of the user entities communicating via a first communication environment based on a first protocol, the method comprising:
maintaining in a controller entity information regarding the status of said at least one user entity, said controller entity being provided in a second communication environment operating in accordance with a second protocol;
signalling from the controller entity a message to the at least one user entity;
relaying the message by a server arranged to operate in the first communication environment; and
receiving the message in the at least one user entity, said message being signaled via the first communication environment.

42. A method as claimed in claim 41, wherein a user entity requests for a membership in a messaging group managed by the controller entity by sending a request to a server provided in the first communication environment.

43. A method as claimed in claim 41, wherein status information regarding said at least one user is signaled from the controller entity.

44. A method as claimed in claim 43, wherein a notification is given to a user of a user equipment receiving the status information.
